(19) United States
(12) Patent Application Publication
(10) Pub. No.: US 2023/0145806 A1
(43) Pub. Date: May 11, 2023

(54) Temperature Measurement Device and Temperature Measurement Method

(71) Applicant: Nippon Telegraph and Telephone Corporation, Tokyo (JP)

(72) Inventors: Daichi Matsunaga, Tokyo (JP); Yujiro Tanaka, Tokyo (JP); Michiko Seyama, Tokyo (JP)

(21) Appl. No.: 17/917,587

(22) PCT Filed: Apr. 28, 2020
(86) PCT No.: PCT/JP2020/018095

§ 371 Date: Oct. 7, 2022

(51) Int. Cl. G01K 17/20; G01K 15/00

(52) U.S. Cl. CPC G01K 17/20; G01K 15/005

(57) ABSTRACT

An embodiment is a temperature measuring device including a sensor that measures the temperature of a skin surface of a living body and a heat flux on the skin surface, a time constant calculation unit that calculates a time constant of changes in the temperature over time on the basis of the measurement result of the temperature, a thermal resistance derivation unit that derives the thermal resistance of the living body on the basis of the time constant, and a temperature calculation unit that calculates the internal temperature of the living body on the basis of the temperature of the skin surface and the heat flux on the skin surface measured by the sensor and the thermal resistance derived by the thermal resistance derivation unit.

### CROSS-REFERENCE TO RELATED APPLICATIONS

This application is a national phase entry of PCT Application No. PCT/JP2020/018095, filed on Apr. 28, 2020, which application is hereby incorporated herein by reference.

### TECHNICAL FIELD

The present invention relates to a temperature measuring device and a temperature measuring method that measure the internal temperature of a subject such as a living body.

### BACKGROUND

In a substance, for example, a living body, when a certain depth is exceeded from the epidermis toward a deep body, there is a temperature area that is not affected by changes in outside air temperature, or the like, and the temperature of this area is called a deep body temperature or a core body temperature. On the other hand, the temperature of a surface layer of a living body that is susceptible to changes in outside air temperature is called a body surface temperature. The body surface temperature may be measured by a percutaneous thermometer in the related art. The body temperature measured by such a percutaneous thermometer in the related art may not reflect the deep body temperature. Therefore, it is difficult to directly measure the deep body temperature, which is the temperature in the deep area of the living body, like the body surface temperature.

Therefore, the inventor proposed a noninvasive deep body temperature measurement technology for measuring a skin surface heat flux H_{Skin} and a skin surface temperature T_{Skin} by a sensor installed on a skin surface and estimating a deep body temperature T_{core} by using these measured values and biothermal resistance R_{Body} given by initial calibration (see NPL 1 and NPL 2). An equation for estimating the deep body temperature T_{core} is as follows.

T_{core}=T_{Skin}+R_{Body}Hₛₖᵢₙ (1)

However, the technology disclosed in NPL 1 and NPL 2 requires the biothermal resistance R_{Body} to be derived by inputting an initial value of the deep body temperature T_{core} at the time of initial calibration before the start of measurement, so the burden on a person who measures the deep body temperature T_{core} is heavy.

### CITATION LIST

### Non Patent Literature

NPL 1: Daichi Matsunaga, Yujiro Tanaka, Tomoko Seyama, “Study for miniaturization of a noninvasive deep body temperature sensor considering convection change”, 2020 Institute of Electronics, Information and Communication Engineers (IEICE) General Conference, Communication lecture Proceedings 1, B-19-9, 2020
NPL 2: Daichi Matsunaga, Yujiro Tanaka, Tomoko Seyama, “Study of a noninvasive deep body temperature estimation method for convection change in outside air”, 2019 Institute of Electronics, Information and Communication Engineers (IEICE) Communication Society Conference, Communication lecture Proceedings 1, B-19-15, 2019

### SUMMARY

### Technical Problem

The present invention has been made to solve the above problems, and an object of the present invention is to provide a temperature measuring device and a temperature measuring method, capable of reducing the burden on a person who measures the internal temperature of a subject such as a living subject.

### Means for Solving the Problem

A temperature measuring device according to embodiments of the present invention includes: a sensor configured to measure a temperature of a surface of a subject and a heat flux on the surface; a time constant calculation unit configured to calculate a time constant of changes in the temperature over time on the basis of a measurement result of the temperature; a thermal resistance derivation unit configured to derive thermal resistance of the subject on the basis of the time constant; and a temperature calculation unit configured to calculate an internal temperature of the subject on the basis of the temperature, the heat flux, and the thermal resistance.

Furthermore, a temperature measuring method according to embodiments of the present invention includes: a first step of measuring a temperature of a surface of a subject; a second step of calculating a time constant of changes in the temperature over time on the basis of a measurement result of the temperature; a third step of deriving thermal resistance of the subject on the basis of the time constant; a fourth step of measuring the temperature of the surface of the subject and a heat flux on the surface; and a fifth step of calculating an internal temperature of the subject on the basis of a measurement result in the fourth step and the thermal resistance calculated in the third step.

### Effects of the Invention

According to embodiments of the present invention, providing a time constant calculation unit and a thermal resistance derivation unit enables to derive the thermal resistance of a subject at the start of measurement, so that it is not necessary to input the initial value of the internal temperature of the subject and it is possible to reduce the burden on a person who measures the internal temperature.

### BRIEF DESCRIPTION OF THE DRAWINGS

FIG. 1 is a block diagram illustrating the configuration of a temperature measuring device according to an embodiment of the present invention.

FIG. 2 is a diagram illustrating a thermal equivalent circuit model of a living body and a sensor according to the embodiment of the present invention.

FIG. 3 is a diagram illustrating an example of the relationship between a time constant of changes in a skin surface temperature over time immediately after sensor attachment and the thermal resistance of a living body.

FIG. 4 is a flowchart for explaining operations of the temperature measuring device according to the embodiment of the present invention.

FIG. 5 is a block diagram illustrating an example of the configuration of a computer that implements the temperature measuring device according to the embodiment of the present invention.

### DETAILED DESCRIPTION OF ILLUSTRATIVE EMBODIMENTS

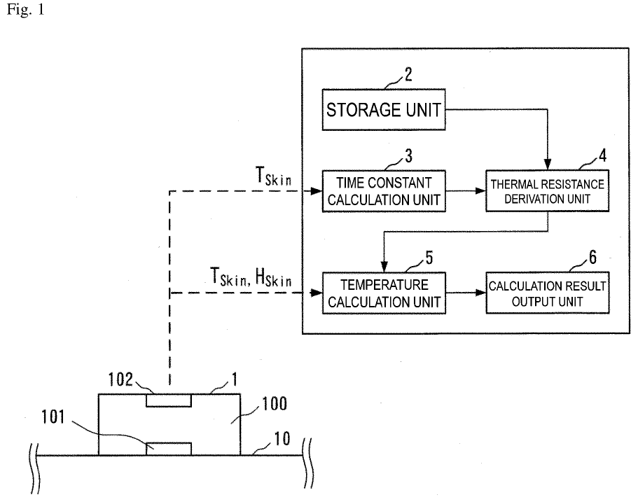

Hereinafter, an embodiment of the present invention will be described with reference to the drawings. FIG. 1 is a block diagram illustrating the configuration of a temperature measuring device according to an embodiment of the present invention. The temperature measuring device includes a sensor 1 that measures a temperature Tₛₖᵢₙ of a skin surface of a living body 10 (subject) and a heat flux Hₛₖᵢₙ on the skin surface, a storage unit 2 that stores in advance a calibration table in which thermal resistance R_{Body} of the living body 10 corresponding to a time constant τ of changes in the temperature Tₛₖᵢₙ over time is registered, a time constant calculation unit 3 that calculates the time constant τ of the changes in the temperature Tₛₖᵢₙ over time on the basis of the measurement result of the temperature Tₛₖᵢₙ, a thermal resistance derivation unit 4 that derives the thermal resistance R_{Body} of the living body 10 on the basis of the time constant τ, a temperature calculation unit 5 that calculates a deep body temperature T_{core} (internal temperature) of the living body 10 on the basis of the temperature Tₛₖᵢₙ, the heat flux Hₛₖᵢₙ, and the thermal resistance R_{Body}, and a calculation result output unit 6 that outputs the calculation result of the deep body temperature T_{core}.

The sensor 1 includes a thermal insulation member 100, a temperature sensor 101 disposed on a surface of the thermal insulation member 100 in contact with the skin of the body 10, and a temperature sensor 102 disposed on a surface of the thermal insulation member 100 on a side opposite to the surface in contact with the skin. By the temperature sensor 101, it is possible to measure the temperature Tₛₖᵢₙ of the skin surface of the living body 10. Furthermore, it is possible to derive the heat flux Hₛₖᵢₙ of the skin surface on the basis of a difference between the temperature Tₛₖᵢₙ of the skin surface and a temperature Tᵤₚₚₑᵣ measured by the temperature sensor 102. The sensor 1 is attached to the skin surface of the living body 10 by, for example, a thermally conductive double-sided tape. The configuration illustrated in FIG. 1 is an example, and the sensor 1 may have a configuration different from that illustrated in FIG. 1.

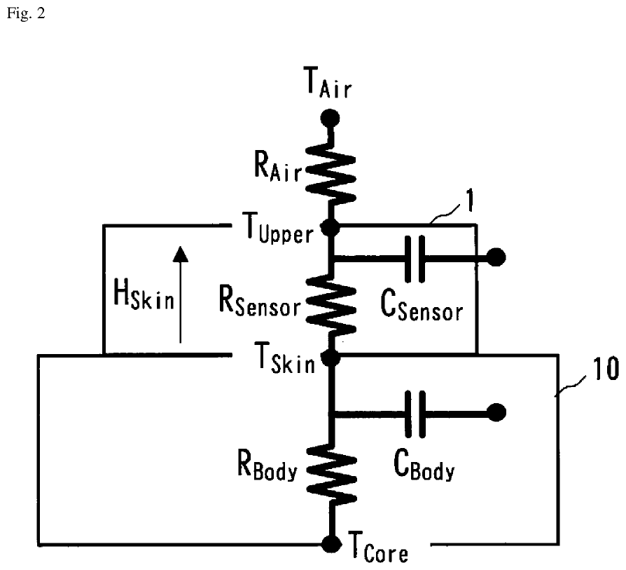

FIG. 2 is a diagram illustrating a thermal equivalent circuit model of the sensor 1 and the living body 10. In FIG. 2, Tᵤₚₚₑᵣ denotes the temperature of an upper surface of the sensor 1 on a side opposite to the surface in contact with the skin of the living body 10, T_{Air} denotes an outside air temperature, R_{Body} denotes the thermal resistance of the living body 10, Rₛₑₙₛₒᵣ is the thermal resistance of the sensor 1, R_{Air} denotes the heat resistance of outside air, C_{Body} denotes the heat capacity of the living body 10, and Cₛₑₙₛₒᵣ denotes the heat capacity of the sensor 1.

The changes Tₛₖᵢₙ(t) in the temperature of the skin surface of the living body 10 over time immediately after sensor attachment and the changes Tᵤₚₚₑᵣ (t) in the temperature of the upper surface of the sensor 1 over time immediately after the sensor attachment are expressed as follows by using the outside air temperature T_{Air}, the deep body temperature T_{Core} of the living body 10, the thermal resistance R_{Body} of the living body 10, the thermal resistance Rₛₑₙₛₒᵣ of the sensor 1, the thermal resistance R_{Air} of the outside air, the heat capacity C_{Body} of the living body 10, and the heat capacity Cₛₑₙₛₒᵣ of the sensor 1.

$$\begin{matrix}[ Math . 1 ] & \\ {T}_{S k i n} ( t ) = {T}_{C o r e} - {R}_{Body} ( \frac{{T}_{S k i n} ( t ) - {T}_{Upper} ( t )}{{R}_{S e n s o r}} + {C}_{Body} {T}_{Skin}^{′} ( t ) ) & ( 2 )\end{matrix}$$

$${T}_{Upper} ( t ) = {T}_{S k i n} ( t ) - {R}_{Sensor} ( \frac{{T}_{Upper} ( t ) - {T}_{A i r}}{{R}_{A i r}} + {C}_{S e nsor} {T}_{Upper}^{′} ( t ) ) \qquad ( 3 )$$

In Equations 2 and 3 above, T_{Skin} (t) indicates the differential of T_{Skin} (t) and Tᵤₚₚₑᵣ (t) indicates the differential of Tᵤₚₚₑᵣ (t).

In Equations 2 and 3 above, with C_{Body}>>Cₛₑₙₛₒᵣ, Equation 4 below is obtained.

$$\begin{matrix}[ Math . 2 ] & \\ {T}_{Skin} ( t ) = ( {T}_{S k i n} ( 0 ) - \frac{{T}_{C o r e} ( {R}_{A i r} + {R}_{S e n s o r} ) + {T}_{A i r} {R}_{Body}}{{R}_{Body} + {R}_{A i r} + {R}_{S e n s o r}} ) exp ( \frac{t}{- \frac{{R}_{Body} {C}_{Body}}{1 + \frac{{R}_{Body}}{{R}_{A i r} + {R}_{S e n s o r}}}} ) + \frac{{T}_{Core} ( {R}_{A i r} + {R}_{S e n s o r} ) + {T}_{A i r} {R}_{Body}}{{R}_{Body} + {R}_{Air} + {R}_{S e n s o r}} & ( 4 )\end{matrix}$$

In Equation 4 above, Tₛₖᵢₙ(o) denotes the skin surface temperature immediately after the sensor attachment. When curve fitting is used to determine the time constant τ of the changes Tₛₖᵢₙ(t) in the skin surface temperature over time that best fits the curve of the changes Tₛₖᵢₙ(t) in the skin surface temperature over time expressed by Equation 4 above, Equation 5 below is obtained.

$$\begin{matrix}[ Math . 3 ] & \\ τ = \frac{{R}_{Body} {C}_{Body}}{1 + \frac{{R}_{Body}}{{R}_{A i r} + {R}_{S e n s o r}}} & ( 5 )\end{matrix}$$

The value of the thermal resistance R_{Air} of the outside air is a constant value under natural convection and the value does not change. The value of the thermal resistance Rₛₑₙₛₒᵣ of the sensor 1 is peculiar to the sensor 1 and the value does not change. The value of the ratio of the thermal resistance R_{Body} and the heat capacity C_{Body} of the living body 10 is peculiar to the tissue of the living body 10. Consequently, the heat capacity C_{Body} can be expressed by the equation below by using the thermal resistance R_{Body}.

C_{Body}=αR_{Body} (6)

In Equation 6 above, a denotes a coefficient. From the above, the thermal resistance R_{Body} of the living body 10 is proportional to the square root of the time constant τ.

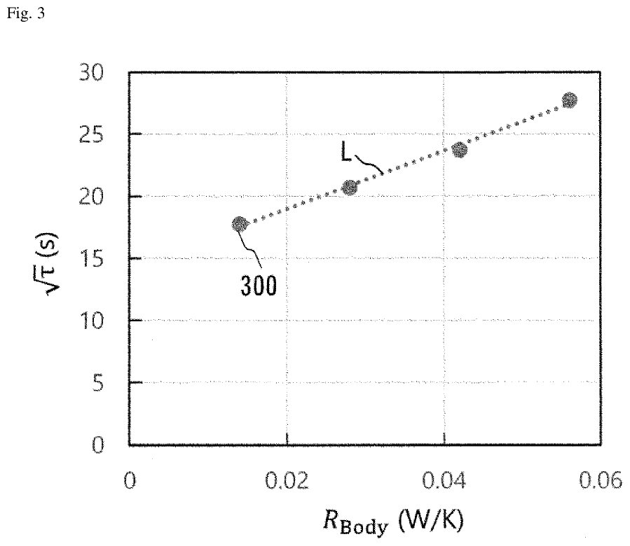

Consequently, as for the body 10 whose deep body temperature T_{core} is to be measured, when the relationship between the time constant τ of the changes Tₛₖᵢₙ(t) in the skin surface temperature over time immediately after the sensor attachment and the thermal resistance R_{Body} of the living body 10 is determined by an experiment, a calibration curve L can be obtained as illustrated in FIG. 3, and the thermal resistance R_{Body} for each time constant τ can be obtained from the calibration curve L. In order to obtain the experimental value (300 in FIG. 3) of the thermal resistance R_{Body} plotted in FIG. 3, when the deep body temperature T_{core} at a part around the sensor 1 after the calculation of the time constant τ is measured by, for example, a heat flow compensation method or an eardrum thermometer and at the same time, the skin surface temperature Tₛₖᵢₙ and the skin surface heat flux Hₛₖᵢₙ are measured by the sensor 1, the thermal resistance R_{Body} corresponding to the time constant τ can be obtained by Equation 1.

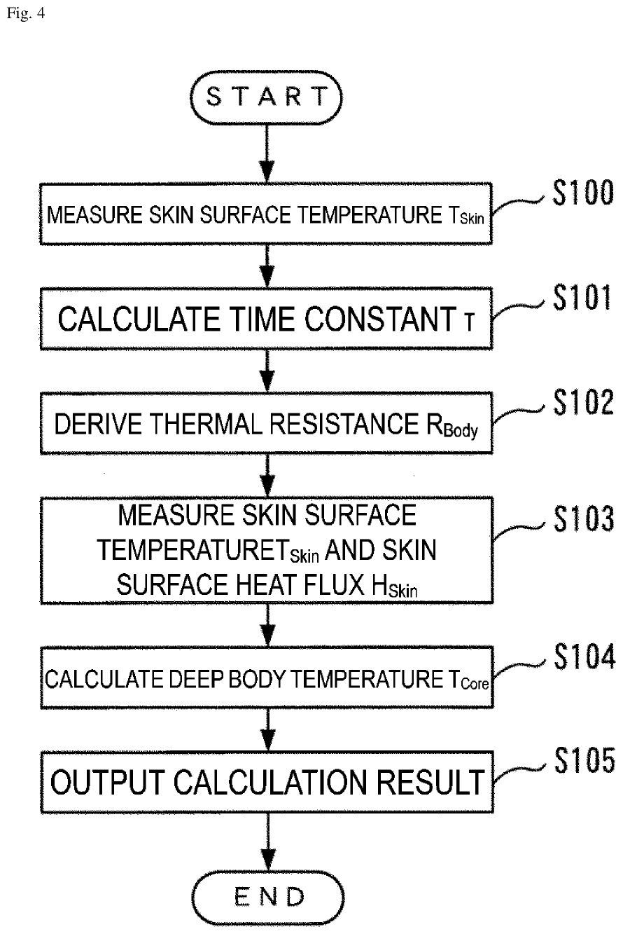

FIG. 4 is a flowchart for explaining operations of the temperature measuring device of the present embodiment. The storage unit 2 of the temperature measuring device stores in advance the calibration table in which the thermal resistance R_{Body} of the living body 10 corresponding to the time constant τ is registered for each time constant τ.

The time constant calculation unit 3 of the temperature measuring device calculates the time constant τ of the changes Tₛₖᵢₙ(t) of the skin surface temperature over time immediately after the sensor attachment on the basis of the result of the continuous measurement (step S100 in FIG. 4) of the skin surface temperature Tₛₖᵢₙ by the sensor 1 (step S101 in FIG. 4). When the skin surface of the living body 10 is covered with the sensor 1, heat is less dissipated from the skin in the covered portion, so the skin surface temperature Tₛₖᵢₙ rises as compared to a portion exposed to the outside air and then reaches a steady-state value. The time constant calculation unit 3 sets, as the time constant τ, the time until the skin surface temperature Tₛₖᵢₙ reaches 63.2% of the steady-state value from the rising time point of the skin surface temperature Tₛₖᵢₙ.

The thermal resistance derivation unit 4 of the temperature measuring device derives the thermal resistance R_{Body} by acquiring, from the calibration table of the storage unit 2, the value of the thermal resistance R_{Body} of the living body 10 corresponding to the time constant τ calculated by the time constant calculation unit 3 (step S102 in FIG. 4).

Next, the temperature calculation unit 5 of the temperature measuring device calculates the deep body temperature T_{Core} of the living body 10 by Equation 1 on the basis of the of result of the measurement (step S103 in FIG. 4) of the skin surface temperature Tₛₖᵢₙ and the skin surface heat flux Hₛₖᵢₙ in a steady state after the calculation of the time constant τ and the thermal resistance R_{Body} derived by the thermal resistance derivation unit 4 (FIG. 4 step S104).

The calculation result output unit 6 of the temperature measuring device outputs the calculation result of the temperature calculation unit 5 (step S105 in FIG. 4). Examples of the output method include the display of the calculation result, the transmission of the calculation result to the outside.

As described above, in the present embodiment, it is not necessary to input an initial value of the deep body temperature T_{core} because it is possible to derive the thermal resistance R_{Body} of the living body 10 only from the calibration table generated in advance, which makes it possible to reduce the burden on a person (a person wearing the sensor 1 or a measurer other than the person) who measures the body temperature T_{core}.

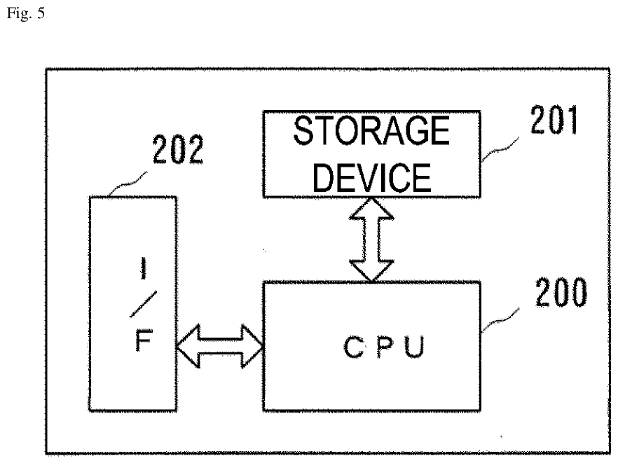

The storage unit 2, the time constant calculation unit 3, the thermal resistance derivation unit 4, the temperature calculation unit 5, and the calculation result output unit 6 described in the present embodiment can be implemented by a computer including a central processing unit (CPU), a storage device, and an interface, and a program that controls these hardware resources. An example of the configuration of the computer is illustrated in FIG. 5.

The computer includes a CPU 200, a storage device 201, and an interface device (hereinafter abbreviated as an I/F) 202. The I/F 202 is for connecting sensor 1, a display device, a communication device, or the like. In such a computer, a program for implementing the temperature measuring method according to embodiments of the present invention is stored in the storage device 201. The CPU 200 executes the processing described in the present embodiment in accordance with the program stored in the storage device 201.

### INDUSTRIAL APPLICABILITY

The embodiments of the present invention can be applied to a technology for measuring the internal temperature of a subject such as a living subject.

### REFERENCE SIGNS LIST

1 Sensor
2 Storage unit
3 Time constant calculation unit
4 Thermal resistance derivation unit
5 Temperature calculation unit
6 Calculation result output unit
10 Living body
100 Thermal insulation member
101, 102 Temperature sensor

1.-4. (canceled)

5. A temperature measuring device comprising:
a sensor configured to measure a temperature of a surface of a subject and a heat flux on the surface;
a time constant calculator configured to calculate a time constant of changes in the temperature over time based on a measurement result of the temperature;
a thermal resistance deriver configured to derive thermal resistance of the subject based on the time constant; and
a temperature calculator configured to calculate an internal temperature of the subject based on the temperature, the heat flux, and the thermal resistance.

6. The temperature measuring device according to claim 5, further comprising a storage device configured to store in advance a calibration table in which thermal resistance corresponding to the time constant is registered for each time constant.

7. The temperature measuring device according to claim 6, wherein the thermal resistance deriver derives the thermal resistance by acquiring, from the calibration table, a value of thermal resistance corresponding to the time constant calculated by the time constant calculator.

8. The temperature measuring device according to claim 5, wherein the time constant calculator is configured to calculate the time constant immediately after the sensor is attached to the surface of the subject.

9. The temperature measuring device of claim 5, further comprising:
a display device to display the calculated internal temperature.

10. A temperature measuring method comprising:
measuring a temperature of a surface of a subject;
calculating a time constant of changes in the temperature over time based on a measurement result of the temperature;
deriving thermal resistance of the subject based on the time constant;
measuring a heat flux on the surface of the subject; and
calculating an internal temperature of the subject based on measurement results of the temperature and the heat flux and the calculated thermal resistance.

11. The temperature measuring method according to claim 10, further comprising:
storing in advance a calibration table in which thermal resistance corresponding to the time constant is registered for each time constant.

12. The temperature measuring method according to claim 10, wherein the thermal resistance is derived by acquiring, from a calibration table stored in advance, a value of thermal resistance corresponding to the calculated time constant.

13. The temperature measuring method according to claim 10, further comprising:
outputting the calculated internal temperature to a display device.

14. The temperature measuring method according to claim 10, further comprising:
sending the calculated internal temperature to a communication device.
